(19) United States
(12) Patent Application Publication
(10) Pub. No.: US 2006/0114249 A1
(43) Pub. Date: Jun. 1, 2006

(54) Liquid crystal display device

(76) Inventor: Yoshihiro Imajo, Mobara (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/335,493

(22) Filed: Jan. 20, 2006

Related U.S. Application Data
(62) Division of application No. 10/212,247, filed on Aug. 6, 2002.

(30) Foreign Application Priority Data
Aug. 16, 2001 (JP) 2001-247284

(51) Int. Cl. G09G 5/00; G09G 3/36

(52) U.S. Cl. 345/211; 345/103

(57) ABSTRACT

A liquid crystal display device includes a first substrate, a second substrate, and liquid crystals interposed between the first and second substrates. A plurality of drain driver semiconductor chips is mounted on the first substrate so as to extend substantially in parallel with one edge of the first substrate, and a drain wiring layer for supplying voltage includes first spaced sections arranged on the first substrate so as to extend substantially in parallel with one edge of the first substrate. Each of the plurality of drain driver semiconductor chips has a bump electrode formed on respective ones of the plurality of drain driver semiconductor chips, and the bump electrode extends substantially in parallel with the another edge of the first substrate. Each end of the bump electrode of the plurality of drain driver semiconductor chips is connected to an end of adjacent first spaced sections of the drain wiring layer.

### CROSS REFERENCE TO RELATED APPLICATIONS

This is a divisional application of U.S. Ser. No. 10/212,247, filed Aug. 5, 2002, the contents of which are incorporated herein by reference.

### BACKGROUND OF THE INVENTION

The present invention relates in general, to liquid crystal display devices; and, more particularly, the invention relates to techniques that are effectively applicable to drive circuitry of a liquid crystal display device of the type employing a scheme for transferring a digital signal between drive circuits (drain drivers).

Liquid crystal display modules of the type which use the so-called super twisted nematic (STN) scheme or thin-film transistor (TFT) scheme and which have a large-size color liquid crystal display panel with a pixel number of 800×480×3 or greater, by way of example, are widely used as display devices for notebook type personal computers or the like. These liquid crystal display devices comprise a liquid crystal display panel and drive circuitry for driving the liquid crystal display panel.

One known example of such liquid crystal display devices uses a scheme (hereinafter referred to as a digital signal sequential transfer scheme) for inputting a digital signal (e.g. display data or clock signal) only to the first or “top” drive circuit of cascade-connected drive circuits, while sequentially transferring this digital signal to the remaining drive circuits through the drive circuits themselves, such as disclosed, for example, in Published Unexamined Japanese Patent Application No. 6-13724 (“JP-A-6-13724”). With the liquid crystal display device disclosed in official gazette JP-A-6-13724, the semiconductor integrated circuit (IC) devices, which constitute the drive circuitry, are directly mounted on a glass substrate of a liquid crystal display panel.

### SUMMARY OF THE INVENTION

FIG. 8 is a block diagram showing an example of the basic configuration of a liquid crystal display panel used in one known liquid crystal display device of the type employing the above-stated digital signal sequential transfer scheme.

As shown in FIG. 8, in a liquid crystal display panel which is provided in a known liquid crystal display device employing the above noted digital signal sequential transfer scheme, a timing controller (or display control device) 110 and drain drivers 130, along with gate drivers 140, are mounted, respectively, at peripheral portions along two sides of an optically transparent dielectric substrate (glass substrate), which serves as the TFT substrate of the liquid crystal display panel 100.

A digital signal (display data, clock signal or the like), which is output by the timing controller 110, and a gray-scale reference voltage (also called, “a color gradation reference voltage”), which is supplied from a power supply circuit 120, are input to each drain driver 130 in such a way that they are first input to the top drain driver 130, and then they are transferred through an internal signal line within each drain driver 130 and along a transfer line path (wiring layer on or above the glass substrate) between respective drain drivers 130.

On the other hand, a power supply voltage for each drain driver 130 is supplied from the power supply circuit 120 through a flexible printed wiring board (simply referred to hereinafter as a “FPC” board) 150 to each drain driver 130.

Similarly, the digital signal (clock signal or the like), which is output from the timing controller 110, is input to each gate driver 140 in such a way as to be input to a top gate driver 140 and then transferred over an internal signal line within each gate driver 140 and along a transfer line path (wiring layer above the glass substrate) between respective gate drivers 140. It should be noted that, on the gate driver side, the power supply voltage for the gate drivers 140, as supplied from the power supply circuit 120, also is supplied to the top gate driver 140 and is then supplied to each gate driver 140 via the internal power line within each gate driver 140 and a transfer line path (wiring layer above the glass substrate).

In this way, in a liquid crystal display device of the type employing the digital signal sequential transfer scheme, both the display data and the clock signal, which are output from the timing controller, are sequentially transferred to each one of the cascade-connected drivers through a signal line within each driver (drain driver 130, or gate driver 140) and a transfer line path (wiring layer above the glass substrate) between respective drivers. However, the power supply voltage, to be supplied to the drain drivers 130, is supplied to each drain driver 130 individually (or in parallel fashion) through the FPC board 150.

On the other hand, although liquid crystal display devices are under a strict requirement for production at low cost, the liquid crystal display device employing the above-stated digital signal sequential transfer scheme has encountered a problem in that it is difficult to attain further cost reduction because the above-mentioned FPC board 150 is inherently high in production cost.

The present invention has been made in order to solve the above-mentioned problem, and an object of this invention is to provide, in a liquid crystal display device employing the digital signal sequential transfer scheme, a technique for enabling a reduction in the cost of production.

The aforesaid and other objects and new features of the present invention will become apparent from the following description provided in this specification and from the accompanying drawings.

Briefly described below are representative examples of the invention disclosed in this application.

A liquid crystal display device according to one aspect of the present invention comprises: a first substrate, a second substrate, and liquid crystals interposed between the first and second substrates, wherein the first substrate has a plurality of semiconductor chips mounted at least along the periphery at two adjacent sides thereof, and at least one of the plurality of semiconductor chips has a power supply terminal for supplying a source voltage for a circuit element in the semiconductor chip which is formed so as to extend along one direction.

In one of the examples for applying the present invention, preferably, to the above-described liquid crystal display device, the plurality of semiconductor chips are divided into a first group mounted on the periphery of the first substrate along a first side thereof and a second group mounted on the periphery of the first substrate along a second side thereof, wherein the respective semiconductor chips belonging to the first group have power supply terminals for supplying a voltage for circuit elements disposed in the semiconductor chips, respectively, which are formed so as to extend along the direction in which the semiconductor chips of the first group are arranged, a wiring layer for electricity supply formed so as to extend along the first side thereof and being divided by areas on which the respective semiconductor chips belonging to the first group are mounted, and both ends of the power supply terminal of each of the semiconductor chips belonging to the first group are connected to the wiring layer for electricity supply, respectively.

Moreover, a liquid crystal display device according to another aspect of the present invention comprises a first substrate, a second substrate, and liquid crystals interposed between the first and second substrates, wherein the first substrate has a plurality of semiconductor chips mounted on at least two adjacent peripheral sides of the first substrate and a pair of wiring layers for electricity supply provided so as to extend and be spaced from one another in an area of the first substrate where one of the plurality of semiconductor chips is mounted. The one of the semiconductor chips has a power supply terminal for supplying a voltage for a circuit element disposed therein, which extends along a direction in which the one of the semiconductor chips and another of the semiconductor chips adjacent thereto are arranged, and both ends of the power supply terminal, provided for the one of the semiconductor chips, are connected to the pair of wiring layers for electricity supply.

Furthermore, a liquid crystal display device according to still another aspect of the present invention comprises: a liquid crystal display element having a first substrate, a second substrate, and liquid crystals interposed between the first and second substrates, and a frame-shaped upper case having an opening exposing one of the main surfaces of the second substrate of the liquid crystal display element as a display area, wherein the first substrate has a plurality of semiconductor chips mounted, respectively, on at least peripheries of the first substrate along two adjacent sides. Further, a thermal conductive film formed of a material having high thermal conductivity (e.g. a high thermal conductive rubber) is provided between one surface of each of the plurality of semiconductor chips, opposite to its other surface facing the first substrate and the upper case.

### BRIEF DESCRIPTION OF THE DRAWINGS

FIG. 1 is a block diagram showing the basic configuration of a display panel of a liquid crystal display module representing an embodiment 1 of the present invention;

FIG. 2 is a block diagram showing the schematic internal configuration of one example of a drain driver shown in FIG. 1;

FIG. 3 is a diagram showing a pictorial representation of a bump electrode formation surface of the drain driver used in the embodiment of this invention and a wiring layer above a glass substrate constituting a TFT substrate;

FIG. 4 is a cross-sectional diagram showing the state in which the drain driver of this embodiment of the invention is mounted on the glass substrate making up the TFT substrate;

FIG. 5 is a diagram showing a pictorial representation of a bump electrode formation surface of a modified example of the drain driver used in the embodiment of the invention;

FIG. 6 is an exploded perspective view showing a schematic arrangement of a liquid crystal display module used in the embodiment of the invention;

FIG. 7 is a diagram showing other features of the liquid crystal display module embodying the invention; and

FIG. 8 is a block diagram showing the basic configuration of a display panel used in a known liquid crystal display module.

### DETAILED DESCRIPTION

One preferred embodiment of the present invention will be explained in detail with reference to the accompanying drawings. Note that, in all of the drawings, parts having similar functions are designated by the same reference numbers, and a repetitive explanation thereof is omitted.

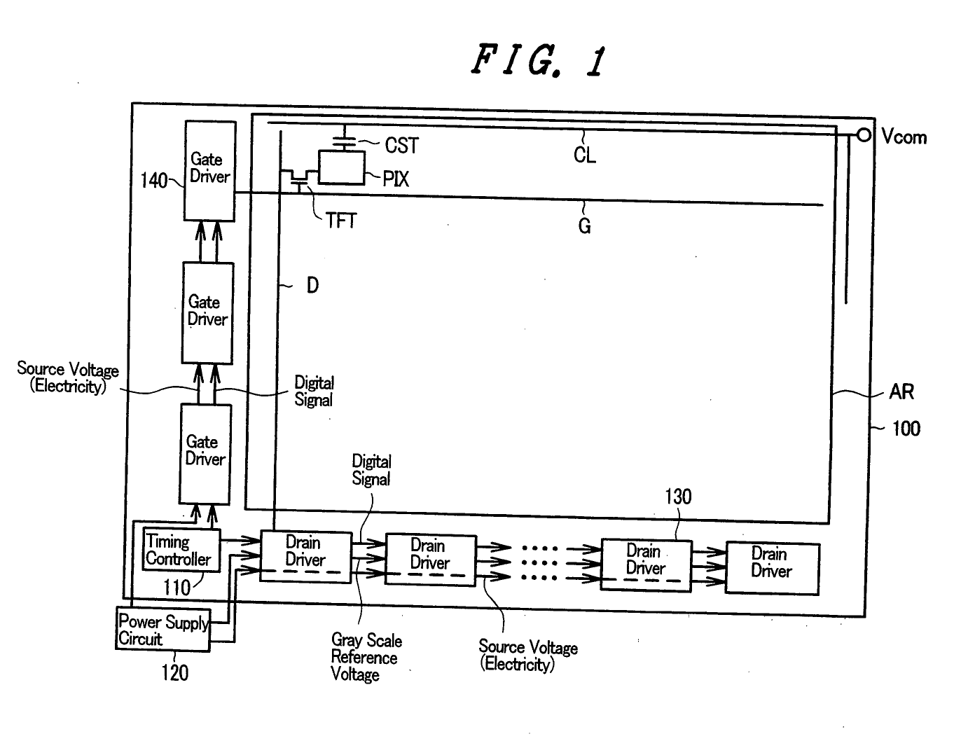

FIG. 1 is a block diagram showing the configuration of a liquid crystal display panel of a liquid crystal display module in accordance with an embodiment of the present invention. Note that in FIG. 1 and FIG. 8, “AR” is used to indicate an effective display region.

The liquid crystal display panel 100 is arranged by superposing a TFT substrate, on which pixel electrodes PIX and thin-film transistors (TFTs) and other elements are formed, and a filter substrate, on which a counter electrode and a color filter are formed with a prespecified spacing or interval defined therebetween. Both substrates are joined together by the use of sealing material, so as to provide a panel having a rectangular frame-like shape at a portion adjacent to the periphery between both substrates. A liquid crystal material is filled into the space inside of the sealing material from more than one liquid crystal sealing inlet port, as provided at part of the sealing material, to thereby seal the liquid crystal inside the sealing material between the substrates. Finally, a polarizer plate(s) is adhered to the outside of both substrates.

Respective picture elements or “pixels”, each having a pixel electrode PIX and a thin-film transistor (TFT), are provided at each of the intersections at which a plurality of scan signal lines (or gate signal lines) G and a plurality of image signal lines (or drain signal lines) D cross one another.

It is noted here that in the illustrative embodiment, a holding or retaining capacitor CST is provided on a per-pixel basis in order to maintain the voltage potential of the pixel electrode PIX; and, additionally, a capacitance line CL is provided for supplying a reference voltage Vcom to the holding capacitor CST. Further note that, although in FIGS. 1 and 8 only a single pixel is depicted, a plurality of pixels, each comprising a pixel electrode PIX and a thin-film transistor (TFT), plus a holding capacitor CST, are provided in a matrix form in the display region AR. Optionally, the capacitance line CL may be replaced with a scan signal line G of its previous line.

The thin-film transistor (TFT) of each pixel has its source connected to a pixel electrode PIX, a drain connected to an image signal line D, and a gate coupled to a scan signal line G, and, thus, it functions as a switch for supplying a display voltage (a gray scale voltage or a color gradation voltage) to the pixel electrode PIX. Note that the names “source” and “drain” are sometimes reversed in relation to the bias being used-here, the one that is coupled to the image signal line D is called the drain.

A timing controller 110, drain drivers 130 and gate drivers 140 are mounted at peripheral portions along two neighboring sides of a transparent dielectric substrate (glass substrate) which serves the TFT substrate of the liquid crystal display panel 100, respectively. And, as described previously, a digital signal (display data, dock signal or the like) that is output by the timing controller 110 and a gray scale or color gradation reference voltage being supplied from a power supply circuit 120 are input to each drain driver 130 in such a way as to be input to a first or “top” one of the drain drivers 130 and then transferred through an internal signal line within each drain driver 130 and along a transfer path (wiring layer above the glass substrate) between respective drain drivers 130.

It must be noted that, in this embodiment, a power supply voltage for each drain driver 130 also is supplied to each drain driver 130 from a power supply circuit 120 through a wiring layer (power-use wiring layer) between respective drain drivers 130 and bump electrodes which are formed on one principal or “main” surface of drain driver 130, in a manner that will be described later. In brief, with this embodiment, the FPC board 150 shown in FIG. 8 can be eliminated.

In addition, the digital signal (clock signal or the like) outputted from the timing controller 110 is input to each gate driver 140 in such a way that the signal is input to the top gate driver 140 and is sent via an internal signal line within each gate driver 140 and along a transfer line path (wiring layer above the glass substrate) between respective gate drivers 140. Additionally a power supply voltage for each gate driver 140, to be supplied from the power supply circuit 120, is input to each gate driver 140 in such a way that it is first supplied to the top gate driver 140 and then is supplied through an internal power supply line within each gate driver 140 and a wiring layer (power-use wiring layer) between respective gate drivers 140.

The timing controller 110 is made up of a single semiconductor integrated circuit (LSI) for controlling and driving the drain drivers 130 and gate drivers 140 based on respective control signals and display data (R, G, and B), which are sent from a computer main body side, wherein the display control signals include a clock signal, a display timing signal, a horizontal synchronizing signal, and a vertical synchronizing signal.

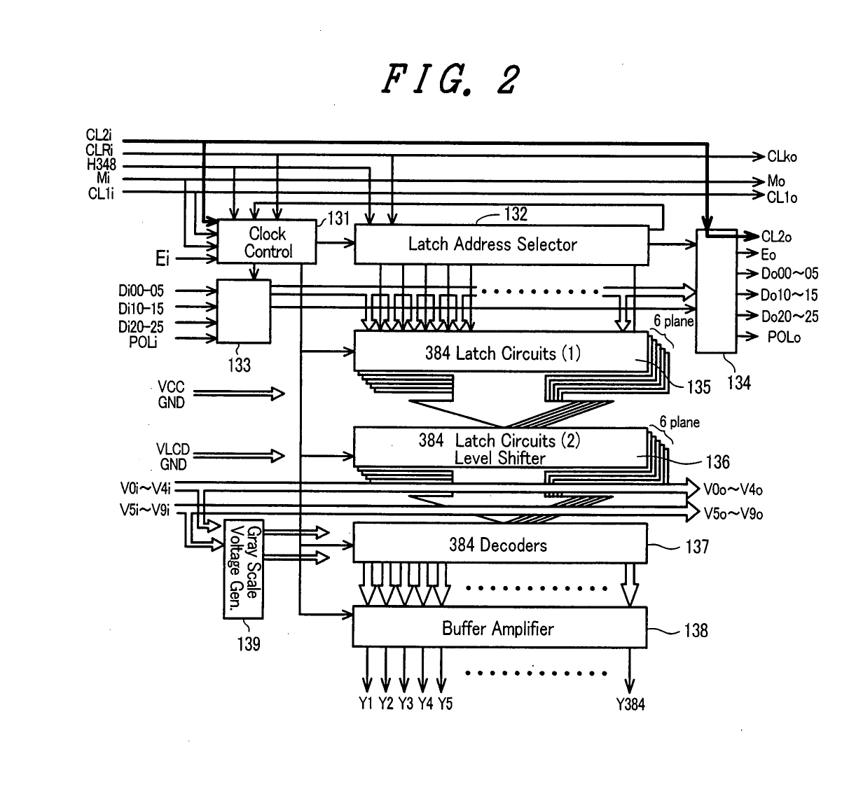

FIG. 2 is a block diagram showing the schematic internal configuration of one example of the drain driver 130 shown in FIG. 1. Note that in FIG. 2, suffix “i” is used to identify an externally input signal, whereas suffix “o” identifies a signal which has been transferred within the drain driver 130 and is being output to the outside. For example, CL2i designates a display data latching clock signal to be input from the outside, whereas CL2o is a display data latch clock signal which has been transmitted through the inside of the drain driver 130 and is being output to the outside (to a dram driver 130 at the next stage).

A latch circuit (1) 135, as shown in FIG. 2 operates in response to a data accept signal received from a latch address selector 132 to sequentially latch display data outputted by a data accepting arithmetic circuit 133. Note that the display data being supplied from the data accept 15 arithmetic circuit 133 also is externally output via a data output circuit 134. Here, the latch address selector 132 generates a data accept signal based on a display data latching clock signal (CL2; hereinafter, simply referred to as clock signal (CL2)) which is sent out by the clock control circuit 131.

Based on an output timing control clock (CL1) sent out of the clock control circuit 131, a latch circuit (2) 136 receives and accepts the display data being presently latched at the latch circuit (1) 135 and then outputs it to a decoder circuit 137. The decoder circuit 137 selects a gray-scale/color-gradation voltage corresponding to the display data sent out of the latch circuit (2) 136 from among 64 gradation levels (64 gray scale levels) of the gradation voltage (the gray scale voltage) supplied from a gradation voltage generating circuit (also called, a gray scale voltage generating circuit) 139, and then outputs the gradation voltage to an amplifier circuit 138. The amplifier circuit 138 amplifies (current-amplifies) the gradation voltage sent out of the decoder circuit 137 and then supplies it to each drain signal line D.

Based on a frame start instruction signal (FLM) sent from the timing controller 110, along with a shift clock (CL3), the gate driver 140 sequentially supplies a select scan voltage of High level to each gate signal line G of the liquid crystal display panel 100 with respect to every single horizontal scan time period. Thus, a plurality of thin-film transistors (TFTs), which are connected to respective gate signal lines G of the liquid crystal display panel 100, are rendered conductive within one horizontal scan time period, causing the gradation voltage (the gray scale voltage) supplied from the amplifier circuit 138 to be applied to each pixel electrode PIX. Thus, an image is displayed on the liquid crystal display panel 100.

In addition, the gradation voltage generator circuit 139 generates a positive gradation voltage having 64 gradation levels, based on the positive gradation reference voltages (V0 to V4) being supplied from the outside, and it also generates a negative gradation voltage with 64 gradation levels, based on the negative gradation reference voltages (V5 to V9) being supplied from the outside.

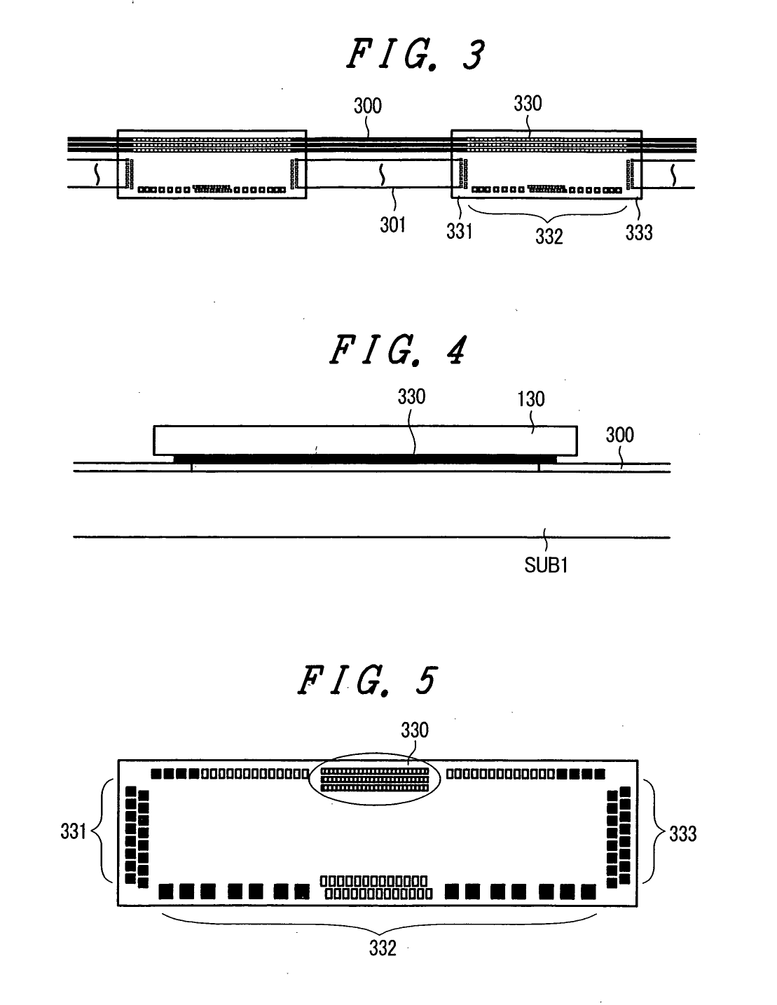

FIG. 3 is a diagram showing a pictorial representation of a bump electrode formation surface of the drain driver 130 of this embodiment and a wiring layer above a glass substrate, which makes up the TFT substrate, and FIG. 4 is a cross-sectional diagram showing the state in which the drain driver 130 of this embodiment is mounted on the glass substrate which serves as the TFT substrate.

As shown in FIG. 3, in the drain driver 130 of this embodiment, bump electrodes 330, to which power supply voltages are supplied, are provided in such a manner as to form lines which linearly extend in the direction along which the plurality of drain drivers 130 are laid out on the substrate. And, as shown in FIGS. 3 and 4, both terminate ends of these extended lines of bump electrodes 330 are connected to wiring layers (power supply wiring layers) 300, which are formed on a glass substrate (SUB 1) making up the TFT substrate. Accordingly, with this embodiment, the power supply voltages (e g, voltages of VCC, GND, VLCD shown in FIG. 2), to be supplied from the power supply circuit 120 to the dram drivers 130, are supplied to the next stage dram driver 130 through the wiring layers 300 formed on the glass substrate (SUB1) making up the TFT substrate and the lines of bump electrodes 330 within each drain driver 130.

It should be noted that, in FIG. 3, reference numeral 331 designates bump electrodes to which digital signals (e.g. display data of D00-D05, D10-D15, D20-D25 and clock signals, such as CL1, CL2, and AC-converted signal (M) or the like, as shown in FIG. 2) and gradation reference voltages (e.g. gradation reference voltages of V0-V9 shown in FIG. 2) are input; and reference numeral 333 denotes bump electrodes from which the above-noted digital signals and gradation reference voltages are output. Additionally, 332 indicates bump electrodes which are connected to the drain signal lines D of the liquid crystal display panel 100. Note here that the bump electrodes (331, 333) are connected to portions of a wiring layer 301 that is formed on the glass substrate (SUB 1) which serves as the TFT substrate.

Generally, for bump electrodes of a semiconductor chip, gold (Au) bumps are used, the thickness of which is set at 15 μm, more or less. In view of the fact that the gold bump electrodes inherently have a lower specific resistance or resistivity than aluminum (Al), which is used for the wiring layers within the semiconductor chip, by way of example, and which, moreover, can be made thicker, while offering a difference on the order of magnitude of one digit or greater, it is possible to lower the resistance value of the bump electrodes. For this reason, as shown in FIG. 1, even when the power supply voltage is supplied to each drain driver 130 through the gold bump electrodes, which are formed on the bump electrode formation surface of drain driver 130, and the wiring layers 300 overlying the glass substrate (SUB 1), without the use of the FPC board 150 shown in FIG. 8, it is possible to reduce any possible variations of the voltage value of the power supply voltage(s) to be supplied to the last-ordered drain driver 130 to a practical level.

It must be noted that the above-described gold bump electrodes can be formed simultaneously at a bump electrode formation step in the presently available manufacturing process, so that use of these pump electrodes does not lead to any appreciable cost increase. Furthermore, with this embodiment, it is possible to eliminate the use of the FPC board 150 shown in FIG. 8; thus, it is possible to further reduce production costs with this embodiment.

FIG. 5 is a diagram showing a pictorial representation of the bump electrode formation surface of a modified example of the drain driver 130 for use in this embodiment. Although, in the drain driver 130 shown in FIG. 5, the bump electrodes also are formed into a linear array form, the drain driver 130 shown in FIG. 5 is the one in which the bump electrodes are for use as power supply wiring lines (power supply wiring lines within a semiconductor chip) within the drain driver.

Generally, while aluminum is used for power supply wiring lines within the semiconductor chip, the aluminum wiring layer has a thickness of several hundreds of nanometers (nm). In contrast, gold bump electrodes for use as the bump electrodes in this embodiment measure about 15 μm in thickness. More specifically, since gold bump electrodes have a lower resistivity than aluminum (Al) and also can be thickened with a difference on the order of magnitude of one digit or more, it becomes possible to provide extremely low resistance power supply wiring lines, which in turn makes it possible to suppress the influence of the resistance of such power supply lines, within the drain driver, upon driver outputs, thus enabling an image, as visually displayed on the liquid crystal display panel 100, to have an improved display quality.

It is noted that, although the above explanation is specifically directed to the case where the linear array of gold bump electrodes is provided only on the drain driver side for supplying power supply voltage(s) to each drain driver 130 via the gold bump electrodes and the wiring layer(s) 300 overlying the glass substrate (SUB1), the present invention should not be limited to only this arrangement and may alternatively be modified so that the gate driver side is arranged similarly.

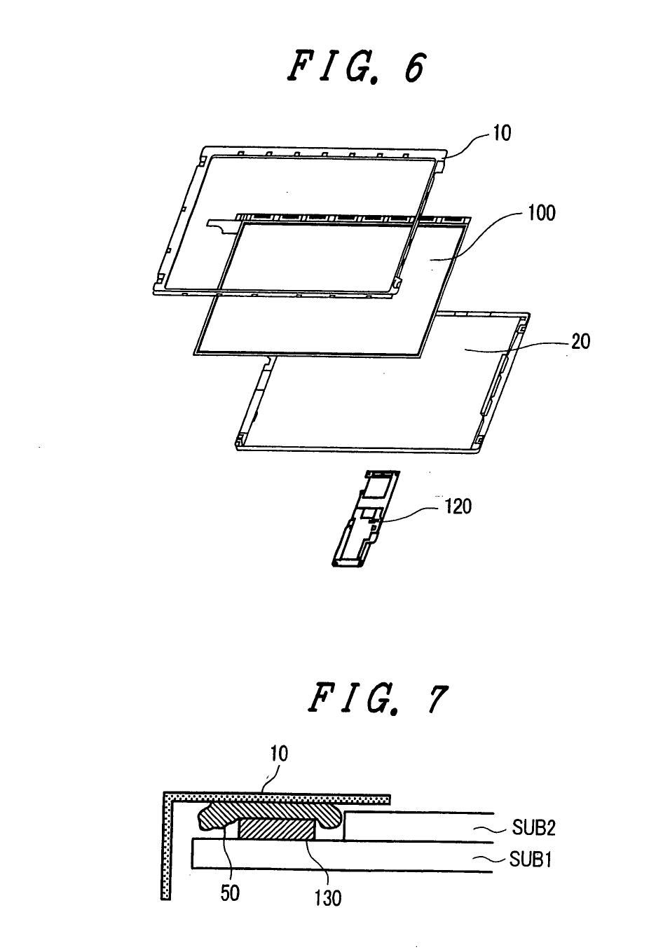

FIG. 6 is an exploded perspective view which schematically shows an example of the structure of a liquid crystal display module of this embodiment. As shown in FIG. 6, the liquid crystal display module of this embodiment is arranged so that its liquid crystal display panel 100 is positioned between a hollow rectangular casing-like frame (upper side case) 10, that is formed of a metal plate, and a back-light unit 20. In addition, the power supply circuit 120 is disposed on the backside of the backlight unit 20.

Note that the backlight unit is generally structured from a cold cathode fluorescent lamp(s), a wedge-shaped (the side shape is like a trapezoid) light guide body, a diffusion sheet(s), a prism sheet(s), a reflective sheet(s), and a housing that receives therein the above-noted respective components; however, the structure of this backlight unit per se has no relation to the present invention, so that a detailed explanation thereof is omitted herein

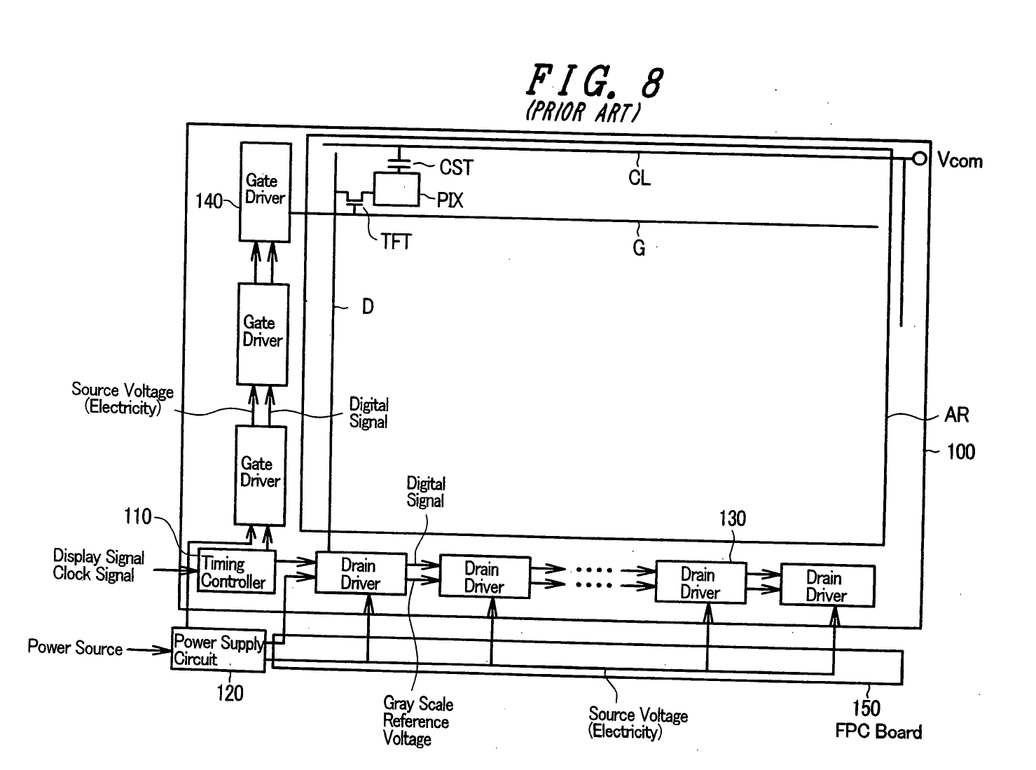

FIG. 7 is a diagram showing other features of the liquid crystal display module of this embodiment. Note that, in FIG. 7, “SUB2” is used to designate a glass substrate which serves as a color filter substrate Also note that, in FIG. 7, only the frame 10, which is shown in FIG. 6, and the associated part of the liquid crystal display panel 100 are depicted, with illustration of the arrangement therefor eliminated herein.

If the power consumption of the drain driver 130 is large, then the heat generated by the drain driver 130 increases accordingly. In addition, liquid crystals exhibit a certain temperature dependency, so that a change in the temperature thereof would result in a likewise change in the applied voltage versus transmissivity characteristics. Due to this, it is assumed that, upon application of the heat, that is generated by the drain driver 130, to the liquid crystals of the liquid crystal display panel 100, the applied voltage vs transmissivity characteristics of the panel changes, resulting in the occurrence of luminance irregularities on an image display screen of the liquid crystal display panel 100.

However, with the embodiment of the present invention, a heat conductive film 50, which is made of high thermal conductivity material, such as, for example, high thermal conductive rubber or the like, is provided between the surface opposite to the bump electrode formation surface of the drain driver 130 and the frame 10. With such an arrangement, in this embodiment, even when the power consumption of the drain driver 130 increases, resulting in an increase in the amount of heat generated by the drain driver 130, it becomes possible to conduct the heat created at this drain driver 130 to the metallic frame 10 through the heat conductive film 50, to thereby effectively exhaust the heat through the frame.

In this way, with this embodiment, it becomes possible to prevent the occurrence of any unwanted local luminance irregularities on the display screen of the liquid crystal display panel 100, which otherwise would occur due to the heat generated by the drain driver 130, thus making it possible to improve the display quality of on-screen images being displayed on the liquid crystal display panel 100.

Although the invention made by the present inventor has been explained in detail based on the aforesaid embodiment thereof, it is apparent that the present invention should not be limited only to said embodiment and may be modified and altered in a variety of forms without departing from the scope of the invention.

A brief explanation of an effect obtainable by a representative one of the inventive concepts disclosed herein is as follows.

In accordance with the present invention, in a liquid crystal display device of the type employing the digital signal sequential transfer scheme, it becomes possible to reduce the cost of production of the device.

What is claimed:

1. A liquid crystal display device, comprising:
a first substrate;
a second substrate; and
liquid crystals interposed between the first and second substrates;
wherein a drain wiring layer for supplying voltage includes first spaced sections arranged on the first substrate so as to extend substantially in parallel with one edge of the first substrate, and a gate wiring layer for supplying voltage includes second spaced sections arranged on the first substrate so as to extend substantially in parallel with another edge of the first substrate;
wherein a plurality of drain driver semiconductor chips is mounted on the first substrate so as to extend substantially in parallel with the one edge of the first substrate, and a plurality of gate driver group semiconductor chips is mounted on the first substrate so as to extend substantially in parallel with the another edge of the first substrate;
wherein each of the plurality of drain driver semiconductor chips has a first bump electrode formed on respective ones of the plurality of drain driver semiconductor chips and the bump electrode extends substantially in parallel with the one edge of the first substrate, and each of the plurality of gate driver semiconductor chips has an internal signal line within each gate driver semiconductor chips; and
wherein each end of the bump electrode of the plurality of drain driver semiconductor chips is connected to an end of adjacent first spaced sections of the drain wiring layer.

2. A liquid crystal display device according to claim 1, wherein the bump electrode is formed so as to linearly extend along the drain driver semiconductor chips.

3. A liquid crystal display device according to claim 1, wherein the bump electrode comprise gold.

4. A liquid crystal display device according to claim 1, wherein the internal signal line within each gate driver comprises aluminum.

5. A liquid crystal display device, comprising:
a first substrate;
a second substrate; and
liquid crystals interposed between the first and second substrates;
wherein a plurality of drain driver semiconductor chips is mounted on the first substrate so as to extend substantially in parallel with one edge of the first substrate;
wherein a drain wiring layer for supplying voltage includes first spaced sections arranged on the first substrate so as to extend substantially in parallel with the one edge of the first substrate;
wherein each of the plurality of drain driver semiconductor chips has a bump electrode formed on respective ones of the plurality of drain driver semiconductor chips, and the bump electrode extends substantially in parallel with the another edge of the first substrate; and
wherein each end of the bump electrode of the plurality of drain driver semiconductor chips is connected to an end of adjacent first spaced sections of the drain wiring layer.

6. A liquid crystal display device according to claim 5, wherein the bump electrode is formed so as to linearly extend along the drain driver semiconductor chips.

7. A liquid crystal display device according to claim 5, wherein the bump electrode comprises gold.

8. A liquid crystal display device according to claim 5, further comprising:
a plurality of gate driver semiconductor chips mounted on the first substrate so as to extend substantially in parallel with another edge of the first substrate;
a gate wiring layer for supplying voltage includes second spaced sections arranged on the first substrate so as to extend substantially in parallel with the another edge of the first substrate.

9. A liquid crystal display device according to claim 8,
wherein each of the plurality of gate driver semiconductor chips has an internal signal line within each gate driver semiconductor chips.

10. A liquid crystal display device according to claim 9, wherein the internal signal line within each gate driver comprises aluminum.
